(19) United States
(12) Patent Application Publication
(10) Pub. No.: US 2013/0046620 A1
(43) Pub. Date: Feb. 21, 2013

(54) Fast and Versatile Graphical Scoring Device and Method, and of Providing Advertising Based Thereon

(71) Applicant: Picscore Inc., Beverly Hills, CA (US)

(72) Inventors: Avery Colorado Pahls, Beverly Hills, CA (US); Alexis Nepomuceno, Olympia, WA (US); Ben Maxstadt, Coeymans Hollow, NY (US)

(73) Assignee: Picscore Inc., Beverly Hills, CA (US)

(21) Appl. No.: 13/659,855

(22) Filed: Oct. 24, 2012

Related U.S. Application Data
(63) Continuation-in-part of application No. 13/297,041, filed on Nov. 15, 2011.
(60) Provisional application No. 61/414,514, filed on Nov. 17, 2010.

(51) Int. Cl. G06Q 30/02

(52) U.S. Cl. 705/14.49

(57) ABSTRACT

A graphical user interface presents an image to a user and at least one labeled axis of that image corresponding to evaluations by the user of the image or of something represented by the image. The user moves a computer mouse or other input device to select a single location on the image. The display screen provides immediate feedback to the user of the location currently being pointed to by the input device (e.g., the x and y coordinates currently being moused over in the case where two labeled axes are employed). The user then selects the location on the screen being pointed to, thus inputting his dimensional evaluation. Optionally, based on the user's dimensional evaluation, advertisements can then be presented to the user according to the user's likes and dislikes. Alternatively or in addition, different users that make similar (e.g., the same) evaluations may be informed of such and given the option to communicate with each other.

### CROSS-REFERENCE TO RELATED APPLICATIONS

This application is a continuation-in-part of U.S. patent application Ser. No. 13/297,041 filed Nov. 15, 2011, which claims the benefit of U.S. provisional application No. 61/414,574 filed Nov. 17, 2010, the entire contents of which are hereby incorporated by reference as if set forth herein.

### BACKGROUND OF THE INVENTION

1. Field of the Invention

This invention relates to the field of obtaining feedback from individuals, and of serving or otherwise providing advertising to those individuals based on that feedback. More particularly, this invention relates to a fast and versatile method of obtaining polling information from individuals, and serving advertisements to those individuals based the polling results, and a device for doing so that is particularly well suited for implementation using the Internet, smart phones, and other interactive devices.

2. Description of Related Art

Obtaining feedback and scoring from users, who can be customers or simply general members of the public, is useful in a wide variety of applications. Feedback and scoring mechanisms are becoming more and more popular over the Internet. A news website might ask readers on its home page to click a radio button and thereby cast a straw vote for one candidate on a slate of candidates. Another website asks readers to state their opinions on current topics of interest and/or debate, e.g., “Would you object to a full-body scan or pat down at airport security? ∘ Yes ∘ No.” That question allows users to input only what constitutes a binary score, i.e., “yes” or “no.” Another more sophisticated website and polling system allows users to rate college professors by giving the professor a score of 1-5 in each of various different categories including “easiness,” “helpfulness,” and “clarity.” Consumer feedback information including consumer ratings can be extremely valuable marketing information, and hence companies have been placing increasing efforts into obtaining consumer feedback including ratings of its products or services in a number of different categories. It is also important to target advertising to users based on their interests.

### SUMMARY OF THE INVENTION

The present invention is of a method and associated device that may be implemented over a computer network such as the Internet or other interactive devices, and that provides a fast, interactive, easy, and fun to use interface for people to provide ratings, i.e., scores. By providing a fast, intuitive, and fun-to-use interface, the present invention makes websites at which people can score products, services, people, etc., more attractive to Internet users and hence helps to generate website traffic and also helps the website operator to gather information about people's likes and dislikes for marketing purposes. Additionally, by allowing the website operator to gather multidimensional information about the user's likes and dislikes or other reactions, the website operator can then provide various services including, for example, presenting advertising on behalf of advertisers to the users, communicating with users in the event multiple users have similar scores, offering on behalf of advertisers targeted deals that can be, for example, in the form of coupons to the user, and so on.

The advertizing may be presented to a user based on the user scoring an image. For example, an advertisement may be displayed within an image as a result of a user scoring that image. As another example, the specific advertisement presented to a user may be selected depending on the score entered by the user.

The communication with users may take different forms in different embodiments. In some embodiments, users are informed that their score matches the score of other users. In some embodiments, communication between the users is enabled as a result of the users having matching or similar scores.

The coupons can be single dimension coupons such as 10% off of a particular product, or can be a package deal such as 2-for-one entrance to a particular theme park plus 20% off at a particular restaurant within that theme park. The coupons can be free coupons given to the user, or they can be sold to the user. Revenue can thus be derived from the advertiser and/or from the user, and/or from other advertisers on the web page such as click-through advertising.

Exemplary embodiments of the invention will be further described below with reference to the drawings, in which like numbers refer to like parts. The drawing figures might not be to scale, and certain components may be shown in generalized or schematic form and identified by commercial designations in the interest of clarity and conciseness.

### BRIEF DESCRIPTION OF THE DRAWINGS

FIGS. 1A-1B illustrate an exemplary graphical scoring interface and advertisement presented to a user according to a first embodiment of the invention.

FIG. 2 illustrates exemplary operations relating to presenting an advertisement to a user according to the first embodiment of the invention.

FIGS. 3A-3B illustrate an exemplary graphical scoring interface presented to users and communication with the users according to an optional feature and/or a second embodiment of the invention.

FIG. 4 illustrates exemplary operations relating to communicating with users according to an additional option and/or a second embodiment of the invention.

FIGS. 5A-5B illustrate an exemplary graphical scoring interface and scoring presented to a user according to an additional option and/or a third embodiment of the invention.

FIG. 6 illustrates a commercial offer that can be presented to the user based upon the scores provided by the user in FIG. 5.

FIGS. 7A-7B illustrate additional commercial offers that can be presented to the user based upon the scores provided by the user in FIG. 5.

FIG. 8 illustrates an exemplary system for presenting a graphical scoring interface to at least one user and providing other services for the at least one user.

### DETAILED DESCRIPTION OF THE PREFERRED EMBODIMENTS

### User Interface

The user interface is provided by a device having a controller, such as a general purpose computer, a display screen (e.g., for a computer, a portable device, etc.) and a pointing and selecting device such as a touch screen, a mouse, a joystick, etc. From the perspective of a user, the user interface provides a 2-dimensional graphical interface including an image, by which a user can position his mouse or other pointing and selecting device over the image and quickly and easily score the image in two dimensions (qualities) by positioning an on-screen cursor and then entering a single mouse click. The invention may be implemented using any interactive device including a computer communicating over a network such as the Internet or an intranet, a smart phone, a television having a touch screen, and any other of a variety of interactive devices including tablets (e.g., iPads), cell phones (e.g., iPhones), and interactive devices that have not yet been invented. In the discussion that follows, the invention will be illustrated with respect to an implementation over the Internet, but it will be understood that the invention is not so limited.

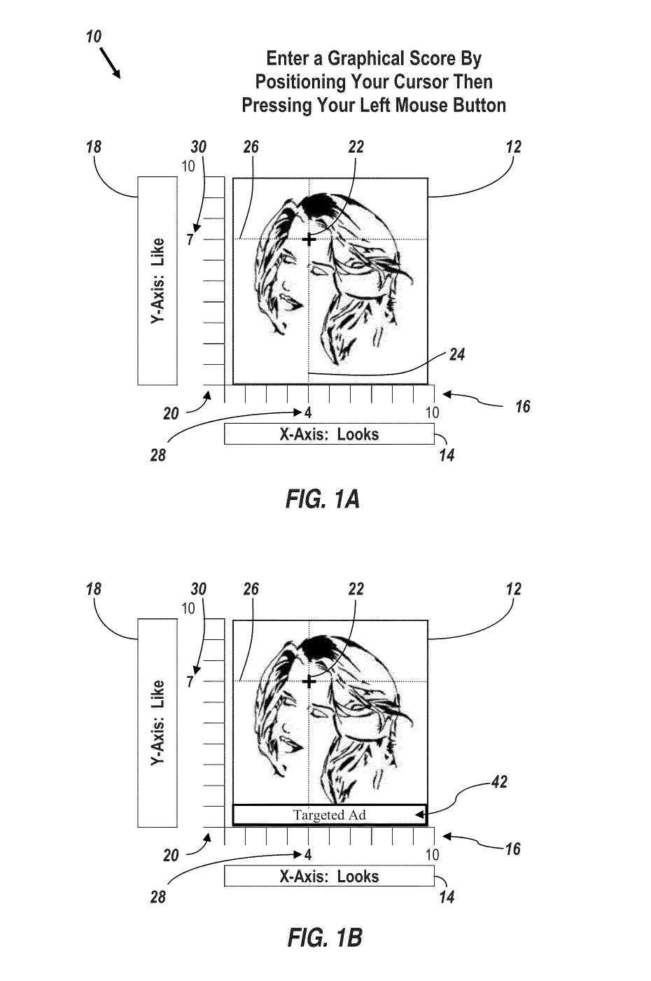

FIGS. 1A-1B illustrates an exemplary graphical scoring interface 10 including results presented to an Internet user according to a first embodiment of the invention. The user may go to a particular page on the world wide web where a graphical image 12 is presented to the user. The x-axis is marked with a first label 14 and an associated numeric scale 16. Similarly, the y-axis is marked with a second label 18 and an associated numeric scale 20. In the example, image 12 is of a well-known actress, x-axis 14 is labeled “Looks,” and the y-axis 18 is labeled “Like.” A user then rates the image itself, or an item or concept that is visually represented by the image, based on the two measures presented, by dragging an on-screen cursor 22, which may be represented by a moving crosshairs. In the example, the user rates the actress based on how much he likes her as an actress and how much he likes her looks. Using “mouseover” commands which are well known to HTML programmers, as the user navigates around the image, numbers on the x and y axis simultaneously light up, or associated crosshair lines 24 and 26 on the x- and y-axes move, and/or digital numeric readouts 28 and 30 on the x- and y-axes update, respectively, to immediately reflect the numeric score associated with the cursor position as the user moves the cursor 22. The image on the screen is thus updated simultaneously with the motion to provide an immediate visual numeric feedback to the user corresponding to the location on the image identified by the user. The feedback mechanism thus provides immediate digital numeric feedback corresponding to the position on the image selected by the user, the user having selected the position on the screen by a single user motion such as moving a joystick or mouse. When the user is satisfied that the cursor position represents the score he wishes to assign to the image, the user then selects that position such as by clicking his left mouse button also referred to as “left clicking.” If the invention is implemented on a device having a touch-activated screen, the user simply touches the screen in the desired location, and thus performs not only the position identification but also the selection action using a single user motion and/or action.

In the example of FIG. 1A, the user has reached a point on the x/y axes indicating that the User “likes” the image/article at a level of 7 or 70% (30), and likes the looks of the image/article at a level of 4 or 40% (28). It should be appreciated that the user can score this image anywhere within the matrix of the x/y axis over the image. Also, an image can be sized to be within the scoring matrix of the x/y axis.

As a result of the user scoring the image, an advertisement is presented to the user. For example, as represented by an exemplary graphical scoring interface in FIB. 1B, the image 12 is modified to include a targeted ad 42.

Thus, in some aspects, an opt-in advertising model is provided where advertisements (ads) are served inside pictures after a user interactively scores a picture. A publisher posts a picture and adds a question (e.g., label) to each axis. Upon seeing the picture, a user “opts-in” by going inside the picture using a mouse, a stylus, a finger, or some other input technique. The moment the user goes inside or over the picture, the system engages the user and the scoring bars move in concert with the movement by the user (e.g., the movement of the mouse, stylus, finger, etc.). The user decides how to score inside the picture with one click, answering one or more questions simultaneously. A contextual, relevant ad (e.g., a deal) is then selected according to the user's selected score and presented to the user (e.g., based on the user's opt-in score or scores), whereby the ad appears in the picture. The user may then elect whether to engage the ad at his or her discretion. The advertising need not necessarily appear within that same image. It could appear elsewhere, including in a pop-up window, a new window, a next screen, an email or other electronic message, or in any other form and delivery method as will be apparent.

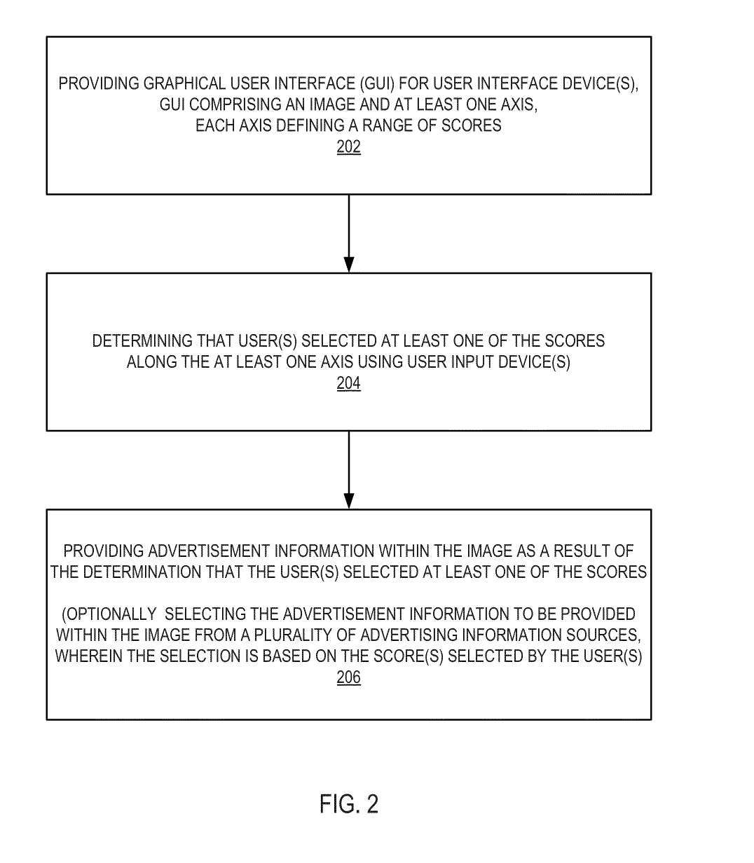

In view of the above, in some implementations, a method of delivering advertising information may involve the operations set forth in FIG. 2.

As represented by block 202, a graphical user interface (GUI) is provided for one or more user interface devices (e.g., computer displays, portable devices, etc.). This GUI comprises an image and at least one axis, where each axis defines a range of scores.

In some cases, the same GUI is provided for multiple user interface devices. For example, multiple users may be asked to score the same image.

As represented by block 204, a determination is made as to whether a user selected at least one of the scores along the at least one axis using a user input device. For example, for an image associated with a single axis (e.g., the X-axis), the user may select a single score (e.g., “4”). As another example, for an image associated with a two axes (e.g., the X-axis and the Y-axis), the user may select a multiple scores (e.g., “4” and “7”) using a single selection action.

In cases where the same GUI is provided for multiple user interface devices (i.e., used by different users), the operations of block 204 involve determining whether each user has entered a score using a corresponding user input device. In such a case, a cumulative score may be determined based on the individual score(s) selected by each user. For example, in implementations that use a cumulative score (e.g., as discussed below), an average, mean, or some other quantity may be calculated based on the individual scores.

As represented by block 206, as a result of the determination at block 204 that at least one user selected at least one score, advertisement information is provided within the image for the user(s). Thus, in some cases, the mere selection of a score by a user will result in an advertisement being served to that user.

In some implementations, the specific advertisement presented to a user is based on the score selected by that user and/or the score(s) selected by at least one other user. Here, the advertisement information to be provided within an image may be selected from a plurality of advertisement sources (e.g., a set of ads associated with a given image, a set of ads associated with a given user, and so on). The selection of which one of these ads is to be presented to a user at a given point in time may thus depend on the score value(s) selected by the user. As another example, the selection of which ad is to be presented to a group of users at a given point in time may be based on the score values selected by the users (e.g., based on a cumulative score that is determined based on these scores).

The image information presented to a user may be generated in different ways in different implementations. Referring again to FIGS. 1A-1B, in one variation, the image 12 and the labeling 14, 18 for the image have been posted by the website operator. In a second variation, the image 12 has been previously posted by a first user who will be referred to as the “Poster,” and who also assigns the x- and y-axis labels 14, 18. Whatever terms the Poster selects for use in the x- and y-axes will be the terms that will be scored by the community of users. The terms to be placed inside in the x- and y-axis labels 14, 18 may be left completely up to the original poster who submits it for the community of users to score. In yet another variation, the user assigns the x- and y-axis labels. The axis labels may be selected from a list of common labels, including such terms as “Like,” “Looks,” “Important,” “Talent,” “Can win the general election,” “trust,” etc. The invention can be used for product and service marketing and survey purposes, with users rating products and services based on criteria such as “like,” “well built,” “economical,” “customer service,” “easy to use,” and any other marketing and/or feedback criteria desired.

The invention can be used for political polling. For example, after a presidential primary debate, a screen containing images of all six primary candidates that took part in the debate can be presented to the user, with the user being asked to score each candidate on criteria such as foreign policy, environment, economic plan, electability, trust, and others. The user can quickly input his views using the invention. In this way, the user can provide his views for each of the six different candidates in each of two different categories (e.g., foreign policy and economic plan) merely by dragging and dropping six different cursors on a single web page or other interface screen. After making a first set of scorings, the user could be presented with another screen allowing the user to input scores for each candidate in two additional categories (e.g., trust and electability in the general election) by simply dragging and dropping six additional cursors. The invention therefore presents a fast, efficient, and easy to use interface that is much more likely to be used by the desired targets of the polling, consumer research, etc.

Numerous categories of items may be presented to the user to score including politicians, athletes, entertainers, music, books, videos, products, services, initiatives and other proposed laws, etc.

The image presented may represent the thing being scored, such as an image of a politician, or it may be the thing itself that is being scored. For example, the user may score paintings, music videos, movie trailers, photographs and logos as paintings, music videos, photographs, etc.

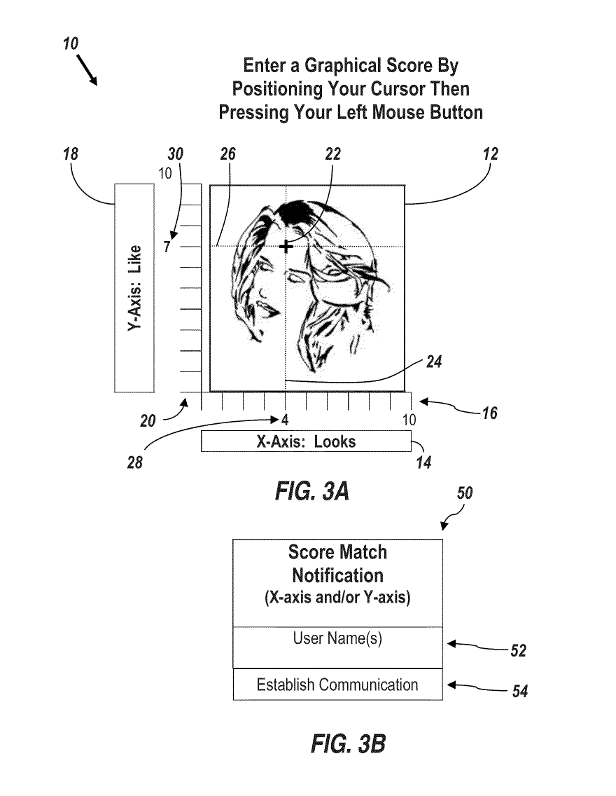

Referring now to FIGS. 3A-3B, in an additional option to the first embodiment, or in what could be a second and separate embodiment, the scores of different users may be compared to determine whether the users selected the same score (or similar scores). If so, actions are taken to inform the users of this match and/or to enable the users to communicate with each another.

For example, a first user may score a picture with a 1 axis question, indicating that the first user likes the picture at 83%. If a second user also scores the picture at 83% (or within a defined range of 83%), the users may be notified of this match. In addition, the system may enable the two users to communicate with one another as a result of this match.

As another example, a first user may score a picture with a 2 axis question, indicating that the first user likes the picture at 83% on the first axis and 90% on the second axis. If a second user also scores the picture at 83% (or within a defined range of 83%) on the first axis and 90% (or within a defined range of 90%) on the second axis, the users may be notified of this match. In addition, the system may enable the two users to communicate with one another as a result of this match.

FIG. 3B illustrates the exemplary graphical scoring interface 10 including a score match notification 50 presented to an Internet user according to this option or embodiment. In this example, the score match notification 50 informs a first user of the user name 52 of each user that selected a score that matched the score selected by the first user. In addition, the score match notification 50 provides a mechanism 54 (e.g., a radio button) that enables the first user to establish communication (e.g., via instant messaging or some other form of communication) with each user that selected a score that matched the score selected by the first user.

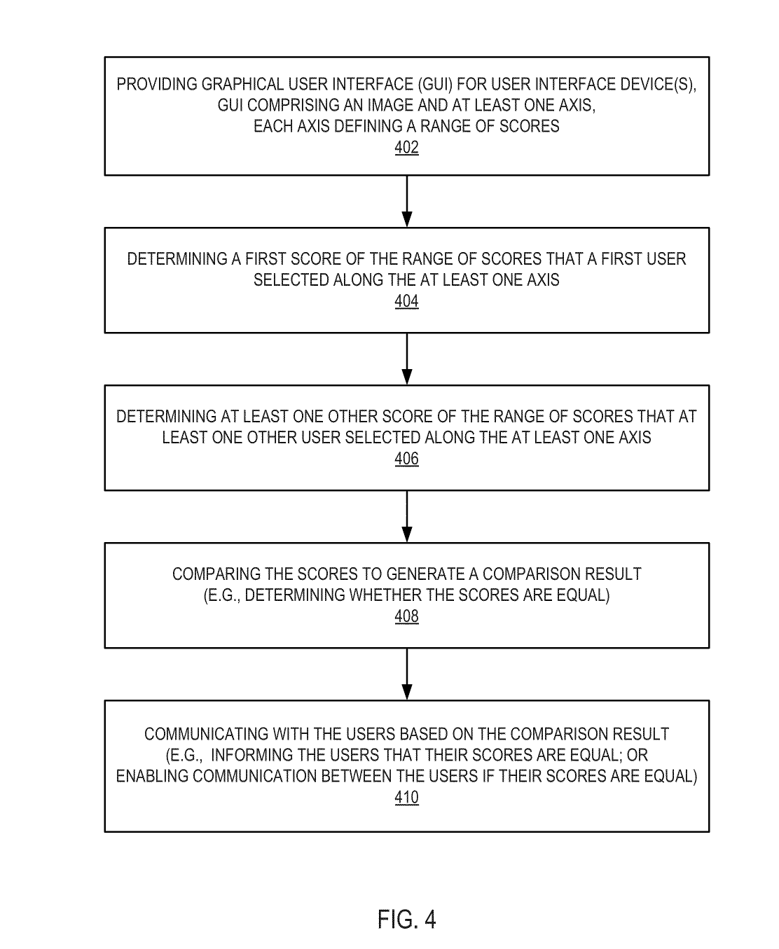

FIG. 4 illustrates an example of a method of communication based on the matching option or embodiment.

As represented by block 402, a graphical user interface (GUI) is provided for one or more user interface devices. This GUI comprises an image and at least one axis, where each axis defines a range of scores.

As represented by blocks 404 and 406, the scores that were selected by different users are determined. For example, for a single axis scenario, the score selected by each user along the axis is determined. For a two axis scenario, the pair of scores selected by each user is determined.

As represented by block 408, the scores of different users determined at blocks 404 and 406 are compared to generate a comparison result. In some cases, this involves comparing the scores to determine whether different users selected the same score. In such a case, the comparison result indicates that the users selected scores that are equal.

In a multi-axis scenario, the scores for a given axis are compared with one another. For example, the X-axis scores for different users may be compared with each other, and the Y-axis scores for different users may be compared with each other.

As represented by block 410, based on the comparison result of block 408, communication with the users may be invoked. For example, if the comparison result indicates that the scores of two or more users are equal, these users may be informed that there is a score match. As another example, if the comparison result indicates that the scores of two or more users are equal, communication may be enabled between these users.

Other types of information may be presented to a user in other options that can be included in the embodiments discussed above, or in additional embodiments. In one such option or embodiment, information such as a users score and coupons are presented to a user.

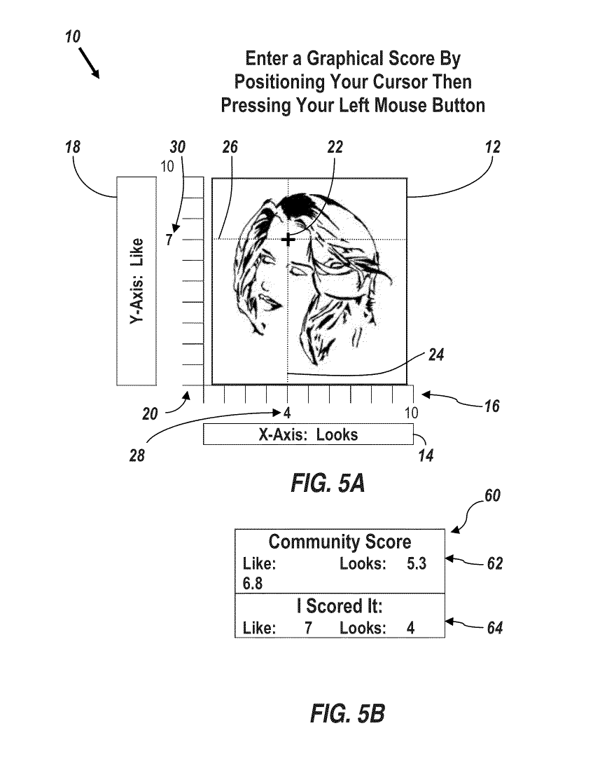

FIGS. 5A-5B again illustrates the exemplary graphical scoring interface 10 including results presented to an Internet user according to an additional option or feature that can be used with any embodiment disclosed herein. In this option or feature, once the user has scored the image, the website then presents the results to the user in results area 60. In the example, the user's own score is reported in user's score reporting area 64, and the user's score is added to, and averaged with, the scored provided by other members of the community, and those average scores are then presented in community score reporting area 62. In this way, the user can see how his own rating of the image compared to other people's ratings for that same image.

The score level range available to the user could be 1-5, or 1-10 as shown in the examples, or 1-100 for finer gradations of scoring, or any other range.

### Commercial Offers

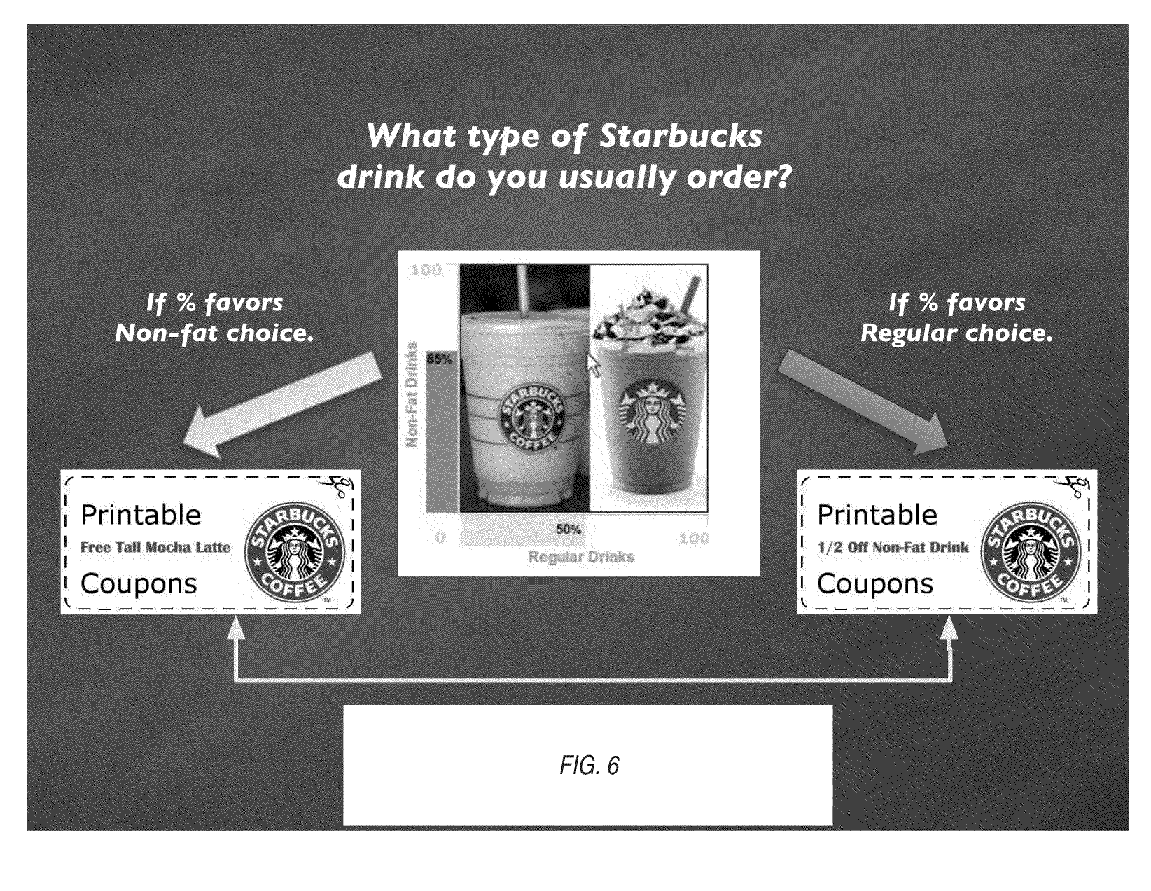

FIG. 6 illustrates a commercial offer than can be presented to the user based upon the scores provided by the user in FIGS. 5A-5B. In this example, the user had been asked to rate commercial products, and more particularly in this case, the user had been asked whether she likes the regular drinks offered by a popular coffee shop and whether she likes the non-fat drinks offered by that shop. The user selected that she likes the regular drinks at a level of 50 out of 100 or 50%, and that she likes the non-fat drinks at a rate of 85 out of 100 or 85%. Based upon the user's preference and scoring, the user is presented with a commercial offer such as a coupon. A simple algorithm might present to the user a printable coupon for the product which she favored the most. If the user favored non-fat drinks at a higher level than regular drinks, she could be presented with a printable coupon for a non-fat drink; similarly, if she favored regular drinks, she could be presented with a coupon for a regular drink. The image(s) and/or text that comprise the commercial offer, in this case the coupon, can be served up either from the website server or from the advertiser's server.

If the user is using the website from a conventional personal computer with an associated hard printer, the coupon can be a printable coupon sent via HTML, PDF, JPEG, or other methods for sending printable objects. Alternatively, the coupon can be an electronic coupon that can be displayed on a smart phone or other portable electronic device, or transmitted from such a device such as via infrared transmission, and hence can be electronically scanned other otherwise read at a point of sale, point of entry, etc. In this way, users who are away from their homes and offices, i.e., who are in the field, can be prompted to go to the website using their portable electronic devices, interact with the website in some way, and can then be sent electronic offers including coupons that can be redeemed in the field.

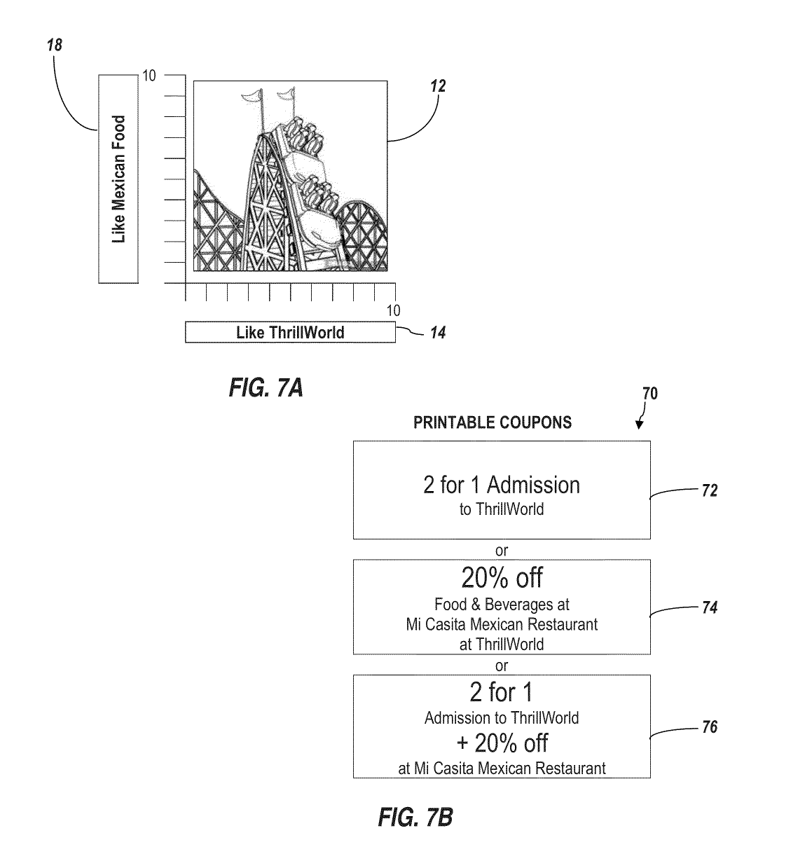

FIGS. 7A-7B illustrates additional commercial offers than can be presented to the user based upon the scores provided by the user in FIG. 5. In this example, the image 12 of a theme park called ThrillWorld is presented to the user, and the user is asked to rate whether he and/or his family like theme parks in general or ThrillWorld in particular, and whether he and/or his family like Mexican food. Depending on how much the user likes ThrillWorld and how much he likes Mexican food, the user could be presented with one or more coupons 70, such as a coupon 72 good for 2-for-1 admission to ThrillWorld, or a coupon 74 good for 20% off at a particular Mexican restaurant in ThrillWorld. Furthermore, the offer could be a package offer, such as coupon 76 that is good for both 2-for-1 admission to ThrillWorld and 20% off at a Mexican restaurant within ThrillWorld. If the user does not like ThrillWorld or does not like Mexican food, the coupon could be for a different theme park or destination, and/or of a different restaurant. In this way, the invention allows a commercial offer such as a coupon to be tailored to a specific user's likes or dislikes, geography, budget, etc.

In another option or variation, the user can be presented with a commercial offer that represents an optimized offer for his selected multiple criteria. For example, an image could be presented of a healthy meal served at a restaurant, with the x and y axes being labeled “Eat Healthy” and “Price.” If the user selects a high value for “Eat Healthy” and a low value for “Price,” the user will be presented with a coupon for a healthy dish at a low priced restaurant, or for a low priced restaurant that features a wide variety of healthy meal selections on its menu.

In a further option or variation, the commercial offer could require some type of immediate payment in exchange for a future benefit such as a future discount. For example, the user could be offered a chance to purchase any one of coupons 72, 74, and/or 76 upon payment of a small fee. In this way, the website operator could obtain revenue both from the advertiser which in this case would be ThrillWorld, from the user, or both.

In another option or variation, the invention could be used by a user to quickly see how numerous items have been ranked. For example, a single web page could present a gallery having a large number of images presented to a user for scoring. Each image can have a reported score visible on the screen, which could represent the score the user gave that image, or could represent the community score, or both values could be displayed in the gallery view. Mousing over a particular image can cause a window to pop up which allows the user to score that image and/or see the community score.

Once an image 12 or video has been scored, either by the user and/or by the community, the image may be presented with an overlay over the image. The image/video can have other data on or around it such as number of people who have score it, the name of the user who originally started the thread by submitting the image/video/link, how to share with friends on a sharing network, comments, video responses, etc. This allows viewers to quickly identify the real time community score that participants have given the subject within the x/y parameters. The user who originally started the thread can set whatever words he chooses for the x- and y-axis labels. The labels chosen will appear over the image.

The graphical user interface thus defines a graphical 2-for-1 experience. As the user navigates over the image, scores on the x/y axis change simultaneously as the on-screen cursor moves, until the User settles his mouse upon a score he/she chooses. The User can then left-click his mouse to record that 2-dimensional (2-parameter) score.

### Programming Details and Examples

As will be appreciated, the invention can be implemented in a variety of different ways, and using various programming languages as desired. Appendix 1 to corresponding provisional patent application Ser. No. 61/414,514 from which priority is claimed and which is incorporated herein by reference, labeled “1-Click Graphical Polling,” provides a graphical illustration of the invention including various options and examples. Appendix 2 to corresponding provisional patent application Ser. No. 61/414,514 from which priority is claimed and which is incorporated herein by reference, labeled “Graphical Polling Software Code,” provides an example of software code that may be used to implement the invention. As will be understood, the Appendix presents one implementation example only, and the functions of the invention may be accomplished using different code and different programming languages from that used in the example.

### Applications

The invention has nearly limitless applications. The invention can be used to allow a number of different Posters/users within an on-line community to upload images for scoring, and other users to score those images.

The invention can be used to allow persons and companies to survey and poll their clients, customers, target audience, etc. Images can be rated on whether the Poster “likes” a person, a video or any other thing, and whether he thinks the person or thing is “important.” Users can rate athletes on whether they think the athlete is “talented” and “contributes positively to the team.” Posters can rate movies on whether they are “funny,” “scary,” “would recommend,” “best picture of the year,” “cinematography,” “acting,” “sound track,” etc. Politicians can be rated on whether they are “honest,” “will run the city efficiently,” etc. Ballot propositions or other proposed legislation can be rated for “the right idea” “well written,” “clarity,” “financial impact,” etc. Users can rate models on the basis of “face” and “body.”

As a non-exclusive list, among the things that can be scored using the present invention are politicians; blogs/individual people ratings; technology (computers, phones, gadgets etc.); sports figures; sports including football, basketball, baseball, NASCAR, horse racing, Olympics, track, boxing, skiing, ice skating, softball, boat racing, and sailing; restaurants; fashion, clothing, and shoes; jewelry; characters in video games; accessories, purses, etc.; dating websites; men and women for dating; individual people; movies; television shows; music; video games; traditional board games and card games; movie trailers; commercials; pets; doctors, lawyers, and other service providers, professional or otherwise; art; cars, trucks, motorcycles, boats, and bicycles; celebrities; beauty products, skin care creams, etc.; fitness products; casinos; bicycles, skateboards, and surfboards; jobs; food; education, quizzes, homework, and tests; environment; camping/outdoor gear; books, magazines, and articles; online auctions; websites; articles; furniture, appliances, and homeware; airlines; gas stations; grocery stores; bars/clubs; beverages; and many others.

### Devices

The x/y scoring axis can be utilized in numerous devices and networks including on the Internet, in closed intranets, or on client side devices. The scoring results can be public for all in the network to see or closed only to those set in specific groups by the company or end user.

The x/y scoring axis can also be applied to video, in a video overlay or embedded manner whether static or live motion.

The invention can be applied to, and implemented within, numerous types of devices and communication networks and communities, including the following as mere examples: desktop and laptop computers; any mobile device with a visual screen including smart phones; television screens; SMS text messaging, sharing networks such as Facebook, Myspace, and Linkedin; web browsers with image content such as Google search, Google Chrome, Firefox, Internet Explorer, and Safari; end user accesses x/y scoring through internet address such as www . . . , or directly via mobile application such as Android or iPhone operating system application; and embedded in other applications including video games or through direct API installation in other applications/partner websites.

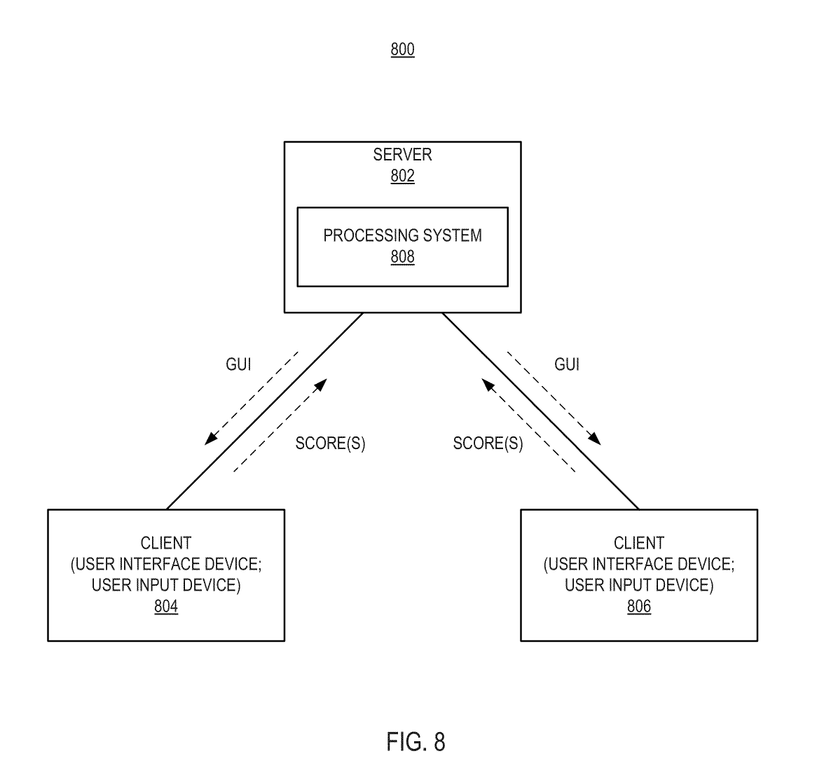

FIG. 8 illustrates an example of a client-server system 800 that may be used to implement the teachings herein in some embodiments. In this example, a server 802 serves clients 804 and 806. It should be appreciated that different implementations may employ a different number of servers (e.g., which may cooperate to serve one or more users), and that a given server will serve different numbers of users over time.

The server 802 includes a processing system 808 (e.g., comprising a controller) for performing processing operations according to the teachings herein. For example, the processing system 808 may be operable to perform the operations of FIG. 2 and/or FIG. 4. To this end, the processing system 808 may define a GUI, modify the GUI as appropriate, and send the GUI to one or more clients.

Each of the clients includes user interface components that enable a user to enter scores and receive services as taught herein. For example, a user of a given client device may view an image and axes of a given GUI via a user interface device (e.g., a display) and operate a user input device (e.g., a mouse, a stylus, a touch screen, etc.) to select a score. The client device will then send the score to the server 802, and the server 802 (e.g., the processing system 808) may modify the GUI (e.g., to include an ad or to communicate information to a user) based on one or more received scores.

### Additional Dimensions

The invention is not strictly limited to two dimensions, but could apply to other dimensions as well. The x/y scoring axis is described herein primarily with reference to a 2-dimensional, 2-axis scoring mechanism. However, the dimensions could be reduced down to 1-axis or go up to 3 or 4 axes surrounding the image. This can also be done in a 3-dimensional manner, with between 1-6 descriptive axes available to be scored.

For example, if a user has a force-based input device, such as a mouse button that senses how hard the user is pushing, the User could score the image in a third dimension at the same time as he scores the image in the first two dimensions, with a three-dimensional image on the screen and numerical values being provided to the user in three dimensions instead of merely two.

Still further, the same image could have multiple sets of axes (grids) provided for rating the same image. For example, the user could select an image of a particular professional athlete, and select the first grid and enter scores for “offensive play” and “defensive play,” and then select a second grid associated with that same image and enter scores for “like” and “overall contribution.” The possibilities are virtually infinite.

### Social Network Applications

The present invention can be used to provide a method of connecting people with similar tastes, outlooks on life, desired activities, etc. In one example, an internet dating site or other social networking could provide one or more images for its users to score and, based upon the score selected by a particular user, suggest people for the user to date or otherwise contact who gave similar scores to the image, or use the scores as a compatibility factor to be used in conjunction with other compatibility factors in matching people based on similar likes, dislikes, interests, political views, etc. More particularly, a user who scores a particular movie high in the categories of both “important” or “musical score” could then be presented with images or profiles of other people who thought that the movie was important and/or had an exceptional musical score, thus giving those people something immediate to talk about as a conversational “ice breaker.” “Meet Up” groups could be suggested to a user based on the user's similarity of likes and dislikes of activities or other things that the user has in common with other members of the different possible groups.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention.

We claim:

1. A method of delivering advertising information comprising:
providing a graphical user interface for a user interface device, the graphical user interface comprising an image and at least one axis, each axis defining a range of scores;
determining that a user selected at least one of the scores along the at least one axis using a user input device; and
providing advertisement information as a result of the determination that the user selected at least one of the scores.

2. The method of claim 1 wherein the advertisement information is provided within the image.

3. The method of claim 2 wherein the advertisement information is provided in the form of an electronic coupon.

4. The method of claim 2 further comprising selecting the advertisement information to be provided within the image from a plurality of advertising information sources, wherein the selection is based on the at least one score selected by the user.

5. The method of claim 2 wherein the at least one score comprises a plurality of scores, the method further comprising:
determining a cumulative score based on the plurality of scores; and
selecting the advertisement information to be provided within the image based on the cumulative score.

6. The method of claim 2 further comprising:
providing the graphical user interface for a plurality of other user interface devices;
determining scores selected by users of the other user interface devices; and
determining a cumulative score based on the scores selected by the users; and
selecting the advertisement information to be provided within the image based on the cumulative score.

7. The method of claim 2 wherein:
the at least one axis comprises a first axis in a first dimension and a second axis in a second dimension; and
the determination that the user selected at least one of the scores comprises determining that the user selected a first score along the first axis and a second score along the second axis.

8. The method of claim 5 wherein:
the graphical user interface includes a first label associated with the first dimension and a second label associated with the second dimension;
the user interface device allows the user to identify a two-dimensional location on the image using a single user motion, the image being updated simultaneously with the motion to provide an immediate visual numerical feedback to the user corresponding to the identified location on the image;
the user interface device further allows the user to select the two-dimensional location on the image using a single user selection action; and
the two-dimensional location selected by the user corresponds to the user's subjective evaluation in two different criteria of at least one of the image itself and something represented by the image, the two different criteria corresponding to the first label associated with the first dimension and the second label associated with the second dimension.

9. The method of claim 8 wherein the single user motion comprises at least one of moving a mouse and touching a touch activated display screen, and the single user selection action comprises at least one of pressing a single mouse button and touching the touch activated screen.

10. A method of communication comprising:
providing a graphical user interface for a plurality of user interface devices, the graphical user interface comprising an image and at least one axis, each axis defining a range of scores;
determining a first score of the range of scores that a first user selected along the at least one axis;
determining a second score of the range of scores that a second user selected along the at least one axis;
comparing the first score with the second score to generate a comparison result; and
communicating with the first user and the second user based on the comparison result.

11. The method of claim 10 wherein:
the comparison comprises determining whether the first score and the second score are equal; and
the communication with the first user and the second user comprises informing the first user and the second user that there is a score match if the comparison result indicates that the first score and the second score are equal.

12. The method of claim 10 wherein:
the comparison comprises determining whether the first score and the second score are within a defined range of each other; and
the communication with the first user and the second user comprises enabling communication between the first user and the second user if the comparison result indicates that the first score and the second score are equal.

13. The method of claim 10 wherein:
the comparison comprises determining whether the first score and the second score are within a defined range of each other; and
the communication with the first user and the second user comprises advising the first and second user that the scores they provided are similar, and giving them the option of communicating with one another.

14. The method of claim 10 wherein:
the at least one axis comprises a first axis in a first dimension and a second axis in a second dimension; and
the first score and the second score correspond to the first axis.

15. The method of claim 14 further comprising:
determining a third score of the range of scores that the first user selected along the second axis;
determining a fourth score of the range of scores that the second user selected along the second axis;
comparing the third score with the fourth score to generate a second comparison result; and
wherein the communication with the first user and the second is further based on the second comparison result.

16. The method of claim 14 wherein:
the graphical user interface includes a first label associated with the first dimension and a second label associated with the second dimension;
the user interface devices allows each of the users to identify a two-dimensional location on the image using a single user motion, the image for each user being updated simultaneously with the motion for the user to provide an immediate visual numerical feedback to the user corresponding to the identified location on the image;
the user interface devices further allow each user to select the two-dimensional location on the image using a single user selection action; and
the two-dimensional location selected by each user corresponds to the user's subjective evaluation in two different criteria of at least one of the image itself and something represented by the image, the two different criteria corresponding to the first label associated with the first dimension and the second label associated with the second dimension.

17. The method of claim 16 wherein the single user motion comprises at least one of moving a mouse and touching a touch activated display screen, and the single user selection action comprises at least one of pressing a single mouse button and touching the touch activated screen.

18. An apparatus for delivering advertising information comprising a processing system operable to:
provide a graphical user interface for a user interface device, the graphical user interface comprising an image and at least one axis, each axis defining a range of scores;
determine that a user selected at least one of the scores along the at least one axis using a user input device; and
provide advertisement information within the image as a result of the determination that the user selected at least one of the scores.

19. A communication apparatus comprising a processing system operable to:
provide a graphical user interface for a plurality of user interface devices, the graphical user interface comprising an image and at least one axis, each axis defining a range of scores;
determine a first score of the range of scores that a first user selected along the at least one axis;
determine a second score of the range of scores that a second user selected along the at least one axis;
compare the first score with the second score to generate a comparison result; and
communicate with the first user and the second user based on the comparison result.
